(19) United States
(12) Patent Application Publication
(10) Pub. No.: US 2015/0056048 A1
(43) Pub. Date: Feb. 26, 2015

(54) ADJUSTABLE AND STOWABLE TRAIN CARGO LIFT SYSTEM AND METHOD

(71) Applicant: Tracy Miller, St. Joseph, MO (US)

(72) Inventor: Tracy Miller, St. Joseph, MO (US)

(21) Appl. No.: 14/216,662

(22) Filed: Mar. 17, 2014

Related U.S. Application Data
(60) Provisional application No. 61/789,175, filed on Mar. 15, 2013.

(51) Int. Cl. B61D 47/00; B60P 1/43

(52) U.S. Cl. CPC B61D 47/005; B60P 1/43
USPC 414/470

(57) ABSTRACT

An adjustable and stowable apparatus for lifting cargo adjacent to a train car catwalk. The lift apparatus is operable to be used in tight spaces and configurable for removal and storage. The lift apparatus may include an actuator that drives a carriage for lifting luggage along a track. The carriage may include a lift basket having a rotatable handle that can be fixed in at least two positions—parallel with and perpendicular to—the track. The rotatable handle is operable to support lifting the cargo in its perpendicular configuration, and carrying and stowage in its parallel configuration.

### CROSS-REFERENCE TO RELATED APPLICATION

This Patent Application claims priority to U.S. Provisional Patent Application Ser. No. 61/789,175 titled Adjustable and Stowable Train Cargo Lift, and filed Mar. 15, 2013, the entire contents of which is incorporated herein by reference.

### BACKGROUND OF THE INVENTION

1. Field

The present inventive concept relates generally to the field of cargo lifting apparatuses and, in particular, embodiments of the present inventive concept relate to an adjustable and stowable apparatus system and method for lifting cargo adjacent to a train car catwalk.

2. Discussion of Related Art

Existing apparatuses for moving cargo onto a train car are configured to be deployed outside the perimeter of the train car, and to assist in the movement of cargo into cargo bays and similar areas designed for relatively open-space loading. Most such existing apparatuses are heavy and clumsy, and not designed for quick and easy use. Further, deployment in areas surrounding the perimeter of a train car also presents increased danger from objects such as other trains and structures which frequently pass by in close proximity to the train car. As such, there is no safe, suitable apparatus in related art for assisting in the loading of personal cargo, for example luggage and personal effects, into the tighter, less open areas of a train car such as a catwalk or similar walkway.

Accordingly, there is a need for an adjustable, stowable train cargo lift that remedies the aforementioned deficiencies in the conventional art.

### SUMMARY OF THE INVENTION

The following brief description is provided to indicate the nature of the subject matter disclosed herein. While certain aspects of the present inventive concept are described below, the summary is not intended to limit the scope of the present inventive concept. Embodiments of the present inventive concept provide an adjustable and stowable apparatus system and method for lifting cargo adjacent to a train car catwalk. The present inventive concept does not suffer from and remedies the deficiencies of conventional apparatus such as those previously set forth herein.

The present inventive concept provides, in its simplest form, an apparatus for lifting train cargo for loading into the tighter spaces of a train car, for example onto a catwalk. In a preferred deployment, the train car is a locomotive or passenger car.

The aforementioned may be achieved in one aspect of the present inventive concept by providing a stowable lift apparatus, including an actuator, a track attached to the actuator, and a carriage slidably attached to the track and in mechanical communication with the actuator. The actuator drives the carriage along the track, preferably in two directions, and is operable to lift cargo seated on the carriage. The actuator in a preferred embodiment includes a threaded drive cylinder operably coupled to a threaded hollow extending through the carriage, whereby rotation of the actuator's threaded drive cylinder causes movement of the carriage along the track. It is foreseen that the actuator may drive the carriage along the track using any of a variety of known means for the transfer of mechanical energy, for example pneumatic or geared drive mechanisms in mechanical communication with a drive shaft, without departing from the spirit of the present inventive concept.

The lift apparatus may be removably attached to the train car. For example, the actuator may be attached to a first means of removably attaching the lift to the train that includes a peg, and the peg may be inserted into an aperture in a step fixed to the train car. The track may also be attached to a second means of removably attaching the lift to the train car that includes an arm slidably attached to the track and fixed to a magnet that is in turn drawn to a piece of metal of the train car, such as a step or sidewall. Still further, the lift apparatus may be attached to a wheel, preferably at one of its ends, for rolling the lift apparatus when it is in a carrying configuration.

The actuator may be controlled by a number of means. For example, a hard-wired control pad may be attached to manipulate the power supply and/or engagement of the actuator, and a limit switch may further be included in the lift apparatus as a mechanical switch for disengaging the actuator once the carriage reaches a pre-determined position along the track. It is foreseen that the control pad may alternatively be wirelessly linked to the remainder of the lift apparatus without departing from the spirit of the present inventive concept. Further, the actuator may draw electrical power from a battery pack, for example a rechargeable 12 Volt battery pack, or from a power cord configured for insertion into and electrical communication with a threaded light socket of a train car.

Still further, the carriage may include a lift basket for securely positioning the cargo. The lift basket may include a flange at its lower end for preventing downward movement of the cargo as it is lifted, and two collapsible bars for supporting cargo against wobbling movement around the track. Alternatively, in the preferred embodiment, the lift basket includes a rotatable carrying handle, for example in the shape of an elongated rectangle with rounded edges, that may be locked in place for carrying with its length parallel to the length of the track, or that may be unlocked, repositioned and re-locked with its length perpendicular to the length of the track thereby presenting a suitable platform on which cargo may sit during lifting. When lifting has completed, the rotatable carrying handle may once again by unlocked, repositioned, and re-locked in a carrying configuration. The lift basket might further include a means of fixing the cargo to the carriage, for example Velcro straps for wrapping and securing around the cargo.

Additional aspects, advantages, and utilities of the present inventive concept will be set forth in part in the description which follows and, in part, will be obvious from the description, or may be learned by practice of the present inventive concept.

### BRIEF DESCRIPTION OF THE DRAWINGS

Embodiments of the present inventive concept are described in detail below with reference to the attached drawing figures, wherein:

FIG. 1 is an elevated side view of an embodiment of the present inventive concept;

FIG. 2 is an elevated side view of the embodiment of FIG. 1 in a different configuration;

FIG. 3 is a right side view of an embodiment of the present inventive concept detailing means of fixing the lift to a train car;

FIG. 4 is an elevated side view of an embodiment of the present inventive concept installed for use on the side of a train car;

FIG. 5 is an elevated end view of an embodiment of the present inventive concept including a lift basket with a rotatable carrying handle in a lifting configuration perpendicular to the track; and

FIG. 6 is an elevated side view of the embodiment of FIG. 5 installed on steps along the side of a train car and further illustrating two slidable arms depicted in two alternative positions along the track and fixed to a magnet for attachment to the train car.

The drawing figures do not limit the present inventive concept to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the invention references the accompanying drawings that illustrate specific embodiments in which the present inventive concept can be practiced. The embodiments are intended to describe aspects of the present inventive concept in sufficient detail to enable those skilled in the art to practice it. Other embodiments can be utilized and changes can be made to such embodiments without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. As used herein, “threads” refers to a raised helical rib such as that commonly found on a screw.

Existing apparatuses for lifting train cargo for loading on and unloading from train cars are large, heavy and clumsy, unsafe, and not easily stowable or usable in tighter spaces of the train cars. The present inventive concept addresses the aforementioned shortcomings of the related art by providing an apparatus a user may carry into the tighter spaces of a train car with relative ease, for example onto steps leading to its catwalk and other areas meant for human occupation, removably secure to the train car, deploy to lift luggage, and remove for stowage on the train car or elsewhere.

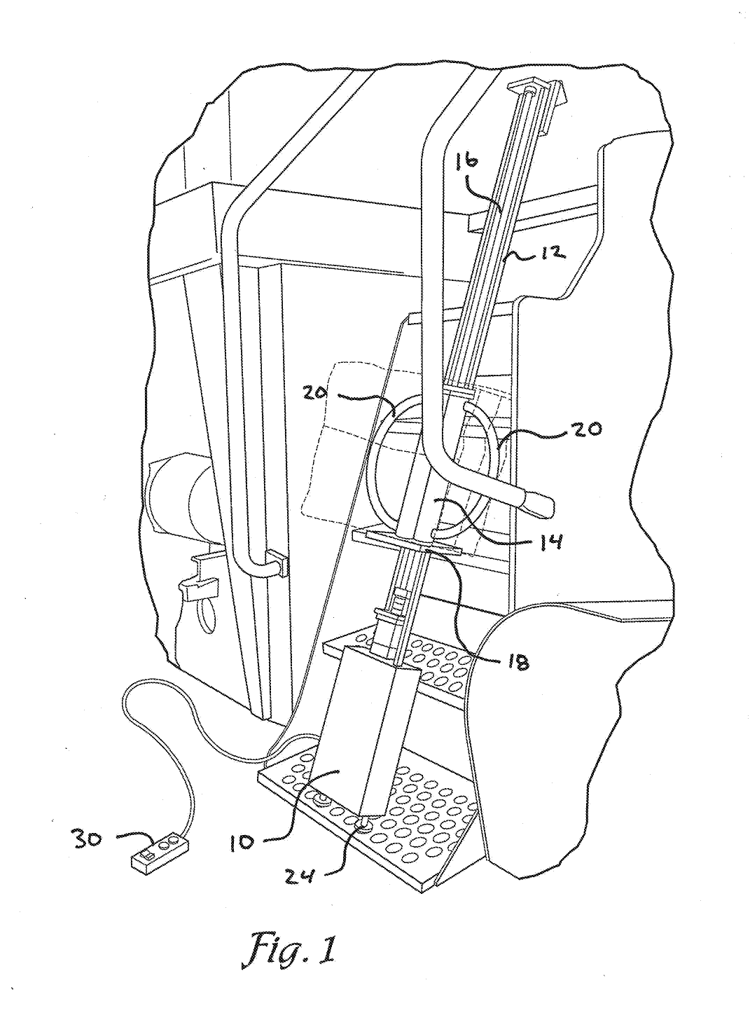

Turning to the drawings and more particularly to FIG. 1, an embodiment of the present inventive concept is illustrated including an actuator 10, track 12, and carriage 14. The actuator 10 includes a motor in a boxy housing fixed to an end of the track 12 that extends away from the boxy housing. The actuator 10 further includes a threaded drive cylinder 16 coupled to the motor and extending along the track 12 in a groove of the track 12. The threaded drive cylinder 16 is rotatably secured to a flange at the terminal end of the track 12.

The threaded drive cylinder 16 is engaged with the carriage 14 at a groove or cylindrical hollow (not shown) in the carriage 14 having threads for engaging the threaded drive cylinder 16. The carriage 14 of FIG. 1 is slidably attached to the track, such that when the threaded drive cylinder 16 rotates within the groove or cylindrical hollow of the carriage 14, the carriage 14 is driven in one of two directions along the track 12, depending on the direction of rotation of the threaded drive cylinder 16. The lift apparatus is thus operable to lift and lower cargo secured to the carriage 14.

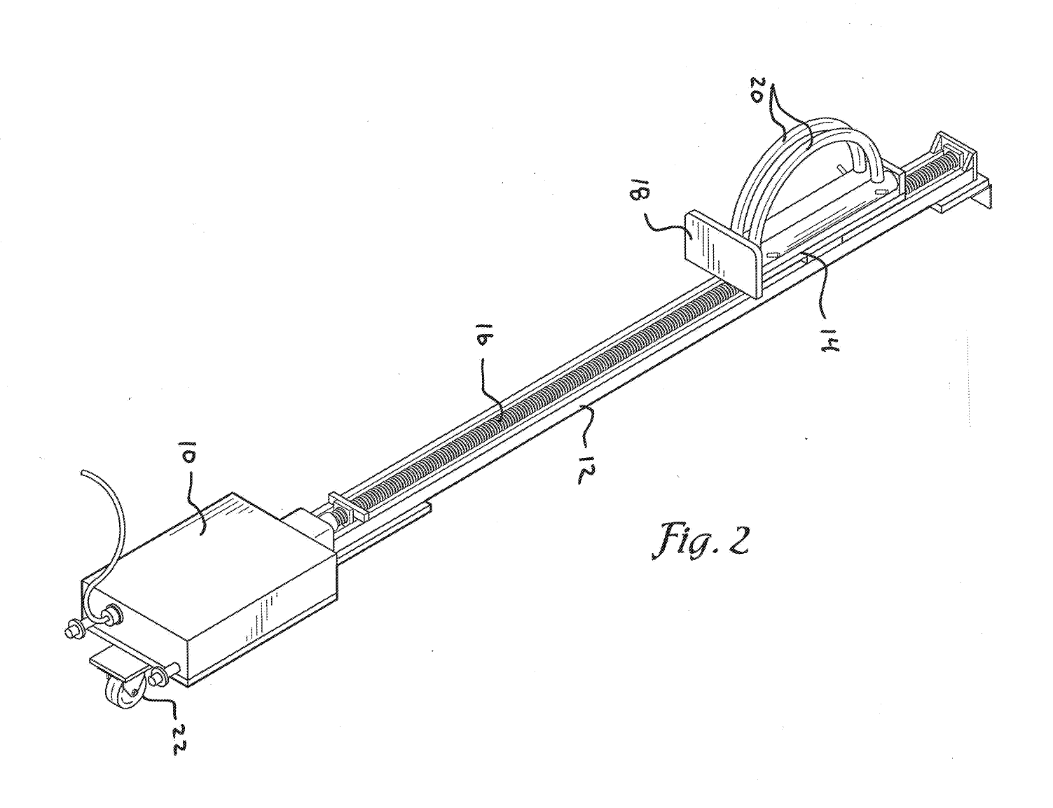

The carriage 14 may include a lift basket for positioning cargo securely on the carriage 14. The lift basket of FIG. 1 includes a flange 18 extending perpendicularly away from the track 12 for supporting the bottom surface of the cargo sitting on the carriage 14, and two collapsible bars 20 extending perpendicularly away from the sides of the track 12 to provide additional support for the cargo and prevent it from falling down along the sides of the track 12. The lift basket of FIG. 1 further includes two rotatable center bars at the center of the carriage 14. The center bars are adjacent and run parallel to one another in the direction of the track 12, and are fixed to the collapsible bars 20. The center bars provide a point around which the collapsible bars 20 may pivot when moving between the locked lifting position illustrated in FIG. 1 and the unlocked carrying position illustrated in FIG. 2. The center bars are locked using retractable pins that extend into complementary receiving apertures in the carriage 14. The center bars may be locked or unlocked, that is the retractable pins may be extended or retracted, respectively, using spring, push button, turn key and/or other mechanisms known in the art for securing and releasing a retractable pin. Further, it is foreseen that mechanisms other than retractable pins may be used to temporarily secure the rotatable bars against rotation without departing from the spirit of the present inventive concept. Still further, it is foreseen that the shape of the bars may vary without departing from the spirit of the present inventive concept.

Turning now to FIG. 2, the embodiment of FIG. 1 is illustrated in a carrying configuration wherein the collapsible bars 20 are rotated to present a narrower effective width of the lift apparatus, and to provide a handle for a user to grab for carrying. The lift apparatus of FIG. 2 further includes a wheel 22 fixed to the boxy housing of the actuator 10 operable to aid the user in carrying the lift apparatus by rolling it along the ground. In another configuration, the carriage 14 may be positioned at a center of gravity of the lift apparatus for easier carrying without reliance on the wheel 22.

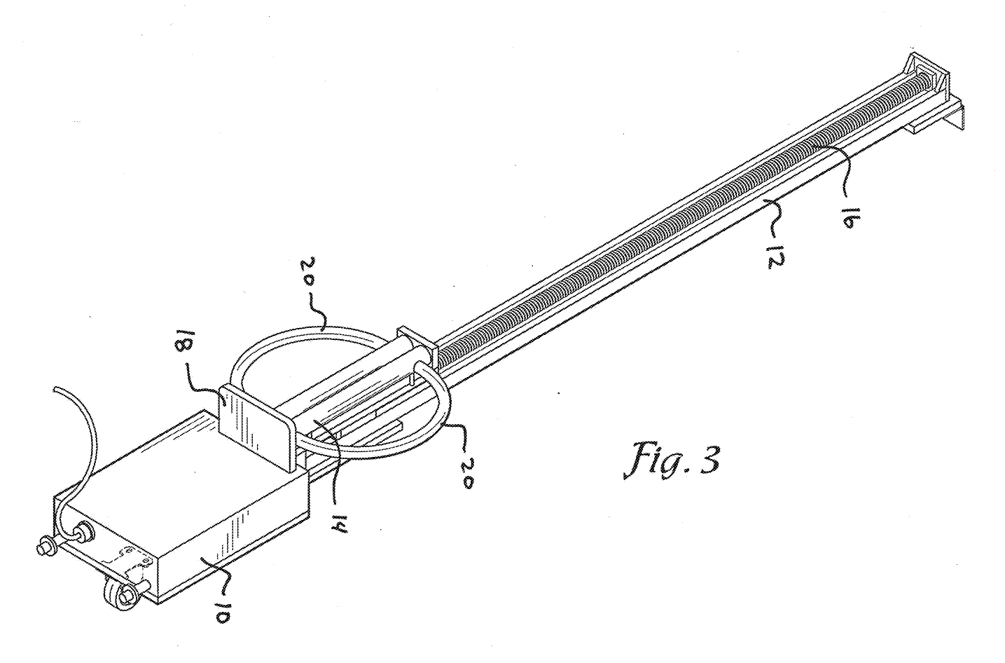

Turning now to FIG. 3, an embodiment of the present inventive concept is illustrated with means for removably attaching the lift apparatus to a train car. A peg 24 is attached to the boxy housing of the actuator 10 and extends from its bottom end parallel to the track 12. The peg 24 may be inserted into an aperture in the train car, such as in one of its steps, or may be threaded and operable as a screw that may be tightened to fix the lift apparatus to a protruding flange or bolt of the train car. A further means for removably attaching the lift apparatus to a train car is illustrated in FIG. 3, and includes an arm 26 pivotally attached to the track 12 via a hinge. The arm 26 extends away from the terminus of the track 12 and the other end of the arm 26 is attached to a magnet 28. In operation, the magnet 28 is attracted to metallic components of the train car, and is operable to removably attach the lift apparatus to the train car. The hinge and movable magnet 28 allow for repositioning and adjustment of the lift apparatus with relative ease. It is foreseen that the lift apparatus of the present inventive concept may employ alternative means for removably attaching the lift apparatus to a train car without departing from the spirit of the present inventive concept. For example, the lower end of the lift apparatus may employ rubber footings or similar materials extending from the bottom of the boxy housing of the actuator to contact a ground surface and provide stability for a lifting operation, while the top of the lift apparatus may employ an arm and magnet to removably attach the lift apparatus to a metallic component of the train car.

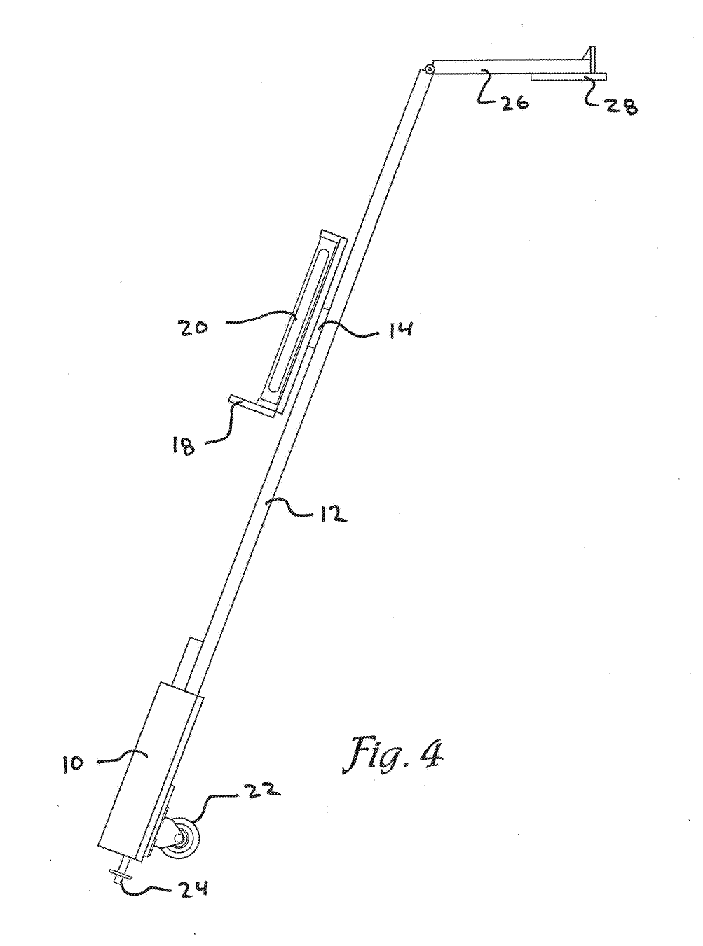

FIG. 4 illustrates a lift apparatus installed on a train car. Two pegs 24 are inserted into apertures in a step of the train car to removably attach the lift apparatus thereto. The lift apparatus then extends upward adjacent to the set of stairs leading to the train's catwalk (not shown) at an approximately twenty degree angle relative to a vertical axis. The embodiment illustrated in FIG. 4 relies on the pegs 24 and the weight of gravity to keep the lift apparatus against the steps during the lifting process. In this configuration, the lift apparatus is easily installed adjacent to the stairs, utilized to lift cargo up onto the catwalk, and may be easily collapsed and carried for stowing on the train car or externally. Also illustrated in FIG. 4 is a control pad 30 operable to manipulate the power supply and/or engagement of the actuator 10 and thus control movement of the carriage along the track 12. One or more limit switches (not shown) may also be installed for disengaging the actuator once the carriage reaches a pre-determined position along the track 12.

FIG. 5 is an elevated end view of an embodiment of the lift apparatus of the present inventive concept. The lift basket of the carriage 14 includes a rotatable carrying handle 32 in the shape of an elongated rectangle with rounded corners that is locked in a lift position substantially perpendicular to the track 12. The rotatable carrying handle 32 is rotatably fixed to the base of the carriage 14 at a pivot dowel (not shown). The pivot dowel is fixed to the base of the carriage 14, and allows the rotatable carrying handle 32 to rotate. The rotatable carrying handle 32 is fixed against rotation in the configuration of FIG. 1 by two retractable pins that extend into complementary receiving apertures 34 of the base of the carriage 14. The rotatable carrying handle 32 may be locked or unlocked, that is the retractable pins may be extended or retracted, respectively, using spring, push button, turn key and/or other mechanisms known in the art for securing and releasing a retractable pin. Further, it is foreseen that mechanisms other than retractable pins may be used to temporarily secure the rotatable carrying handle 32 against rotation without departing from the spirit of the present inventive concept. The lift apparatus further includes a power cord 36 operable to threadably engage a light socket of a train car, and the light socket is operable to supply power to the actuator 10.

To place the lift apparatus in a carrying configuration, a user may unlock the retractable pins, or similar means of arresting rotation of the rotatable carrying handle 32, rotate the rotatable carrying handle 32 approximately ninety degrees so that it is substantially parallel with the track 12, and optionally relock the retractable pins. In embodiments including a wheel (not shown in FIG. 6), the user may wish to position the carriage 14 at a point on the track 12 that is relatively distant from the wheel to allow for easier wheeling of the lift apparatus across the ground. For hand carrying without a wheel, the user may wish to position the carriage at a center of gravity of the lift apparatus for easier carrying. It is foreseen that the lift apparatus may employ alternative carrying means, for example a carrying strap removably attached near the ends of the lift apparatus, without departing from the spirit of the resent inventive concept.

FIG. 6 illustrates a lift apparatus installed on a train car (car illustrated in part) and having a rotatable carrying handle 32 locked in the lift position substantially perpendicular to the track 12. In addition to the rotatable carrying handle 32, the lift basket includes a means of fixing the cargo to the carriage, illustrated as a Velcro strap 38 having two segments fixed to the carriage and wrapping around the cargo for attachment to one another to secure the cargo against the carriage. In addition, the lift apparatus further includes another means of removably attaching the lift apparatus to the train car, including two arms 40 slidably attached to the track 12. FIG. 6 illustrates the arms 40 at two alternative positions along the track 12 to demonstrate the adjustability of this means of attachment. The arms 40 are attached to the magnet 28 for removable attachment to the train car, for example to a step or catwalk of the train car.

Having now generally described the features, discoveries and principles of embodiments of the present inventive concept, the manner in which embodiments of the present inventive concept are constructed and used, the characteristics of the construction, and advantageous, new and useful results obtained; the new and useful structures, devices, tools, elements, arrangements, parts and combinations, are set forth in the appended claims.

It is also to be understood that the following claims are intended to cover all of the generic and specific features of the present inventive concept herein described, and all statements of the scope of the present general inventive concept which, as a matter of language, might be said to fall therebetween.

1. A stowable lift apparatus operable to lift cargo along a train car, the apparatus comprising:
an actuator;
a track attached to the actuator; and
a carriage slidably attached to the track and in mechanical communication with the actuator,
wherein,
the actuator is operable to drive the carriage along the track, and
the stowable lift apparatus is selectively reconfigurable between a use configuration and a storage configuration.

2. The stowable lift apparatus of claim 1, further comprising:
a first means for removably attaching a train car to at least one of (i) the actuator and (ii) the track.

3. The stowable lift apparatus of claim 2, further comprising:
a second means for removably attaching the train car to at least one of (i) the actuator and (ii) the track.

4. The stowable lift apparatus of claim 2, wherein the train car includes a step having an aperture, and the first means includes a peg for insertion into the aperture.

5. The stowable lift apparatus of claim 2, wherein the first means includes a magnet.

6. The stowable lift apparatus of claim 5, wherein the first means further includes an arm fixed to the magnet and slidably attached to the at least one of (i) the actuator and (ii) the track.

7. The stowable lift apparatus of claim 1, further comprising:
a wheel fixed to at least one of (i) the actuator and (ii) the track.

8. The stowable lift apparatus of claim 1, wherein the actuator further includes a threaded drive cylinder for driving the carriage along the track.

9. The stowable lift apparatus of claim 1, further comprising:
a control pad for controlling the movement of the carriage via the actuator.

10. The stowable lift apparatus of claim 1, further comprising:
a limit switch operable to halt movement of the carriage when it reaches a predetermined position along the track.

11. The stowable lift apparatus of claim 1, further comprising:
a battery pack operable to supply power to the actuator.

12. The stowable lift apparatus of claim 1, further comprising:
a power cord operable to threadably engage a light socket of a train car, the light socket operable to supply power to the actuator.

13. The stowable lift apparatus of claim 1, wherein the carriage includes a lift basket operable to securely position cargo relative to the carriage.

14. The stowable lift apparatus of claim 13, wherein the lift basket includes (i) a flange extending perpendicularly away from the track, and (ii) two collapsible bars extending away from the flange and parallel to the track.

15. The stowable lift apparatus of claim 13, wherein the lift basket includes a rotatable carrying handle (i) extending substantially perpendicularly away from the track, and (ii) operable to rotate and be fixed in at least two positions.

16. The stowable lift apparatus of claim 15, wherein the lift basket further includes a means of fixing the cargo to the carriage.

17. The stowable lift apparatus of claim 16, wherein the means of fixing the cargo to the carriage includes a velcro strap.

18. The stowable lift apparatus of claim 13, wherein,
the lift basket is positioned substantially parallel to the track in the use configuration, and
the lift basket is positioned substantially perpendicular to the track in the storage configuration.

19. The stowable lift apparatus of claim 15, further comprising retractable pins for fixing the position of the rotatable carrying handle.

20. The stowable lift apparatus of claim 1, wherein the actuator further includes a pneumatic drive cylinder for driving the carriage along the track.
